(19) United States
(12) Patent Application Publication
(10) Pub. No.: US 2006/0008212 A1
(43) Pub. Date: Jan. 12, 2006

(54) Ferrule for connecting optical fibers and method of producing the same

(76) Inventors: Masanori Wada, Shiga-Ken (JP); Hirokazu Takeuti, Shiga-ken (JP); Azusa Tanaka, Shiga-ken (JP)

Correspondence Address: J C PATENTS, INC., 4 VENTURE, SUITE 250, IRVINE, CA, 92618, US

(21) Appl. No.: 10/523,505

(22) PCT Filed: Jul. 24, 2003
(86) PCT No.: PCT/JP03/09425

§ 371 Date: Jul. 22, 2005

(30) Foreign Application Priority Data
Aug. 8, 2002 (JP) 2002-231364

(51) Int. Cl. G02B 6/36

(52) U.S. Cl. 385/80

(57) ABSTRACT

A ferrule (11) includes an inner hole (12a) that is formed of crystallized glass and into which a quartz glass-made optical fiber (4) (core) is inserted, a tip end face (12b), and an outer circumferential surface (12d). The tip end face (12b) is formed with a flat surface (12b1) on the central side including a tip end opening of the inner hole (12a) and a chamfered portion (12b2) provided on the outer circumferential side of the flat surface (12b1) The chamfered portion (12b2) is subjected to surface treatment so that its wettability with respect to an adhesive (5) is smaller than the wettability of the flat surface (12b1).

### FIELD OF THE INVENTION

The present invention relates to a ferrule for an optical fiber connector used for connecting an optical fiber, and a method of producing the same.

### BACKGROUND OF THE INVENTION

Due to the advancement of an optical communication technique regarding various kinds of devices used in an optical communication field, a high-precision and inexpensive product that can be used easily has been demanded by users. An optical connector is used for connecting an optical fiber used for a transmission path for optical communication. As a member constituting the optical connector, a ferrule for fixing the optical fiber is used. Regarding the ferrule for an optical fiber connector, there is also a demand for the supply of a product that maintains high performance with a reliability and that is easy to use economically at a low cost in the same way as the other products.

Therefore, the ferrule for an optical fiber connector has been variously improved. For example, in Patent Document 1, a tapered chamfered portion having a taper angle of 15° to 45° is provided in a region on an outer circumferential side of a tip end face of a ferrule, and an arc-shaped surface that is provided at a boundary between the chamfered portion and the outer circumferential surface to connect both to each other smoothly. Furthermore, in Patent Document 2, a chamfered portion in a convex shape is provided in a region on an outer circumferential side of a tip end face of a ferrule. Furthermore, in Patent Document 3, in terms of producing a ferrule excellent in characteristics such as mechanical strength at a low cost, a ferrule is formed of crystallized glass having a predetermined composition and characteristics.

FIG. 2 shows an example of a configuration of a general ferrule 1 for an optical fiber connector. The ferrule 1 is composed of a capillary tube portion 2 and a flange portion 3 connected to a rear end portion of the capillary tube portion 2. The capillary tube portion 2 includes an inner hole 2a through which an optical fiber 4 made of quartz glass is inserted, a tip end face 2b, and an outer circumferential surface 2d having a diameter and cylindricity with precision. The tip end face 2b is composed of a flat surface 2b1 on a central side including a tip end opening of the inner hole 2a, and a chamfered portion 2b2 provided on an outer circumferential side of the flat surface 2b1.

The ferrule 1 is assembled as an optical fiber connector plug 10 in a form shown in FIG. 3. The optical fiber 4 (with a covering layer removed: core) is inserted in the inner hole 2a of the ferrule 1 from the flange portion 3 side, and fixed with an adhesive 5. Then, a required portion of the optical fiber 4 projecting from the tip end face 2b of the ferrule 1 is cut, and thereafter, the tip end face 2b of the ferrule 1 is polished together with the tip end face of the optical fiber 4 to be mirror-finished in a spherical shape. The spherical surface polishing of the tip end face 2b of the ferrule 1 is necessary for forming a surface enabling the core of the-optical fiber 4 to be physically joined (PC-joint) in the course of connection as an optical connector. The optical fiber connector plug 10 is used for physically joining (PC-joint) the tip end faces 3b of the ferrules 1 via an adaptor 20 as shown in FIG. 4.

When the optical fiber 4 is inserted in the inner hole 2a of the ferrule 1 and fixed with the adhesive 5, the inner hole 2a is previously filled with the adhesive 5, and the optical fiber 4 is coated with the adhesive 5. After that, the optical fiber 4 is inserted in the inner hole 2a from the flange 3 side. As the adhesive 5, although an epoxy-based adhesive is generally used, a silicone adhesive, an acrylic adhesive, or the like may be used.

Herein, when the optical fiber 4 coated with the adhesive 5 passes through the inner hole 21 of the ferrule 1, and projects from the tip end face 2b as shown in FIG. 5, it is preferable that the adhesion shape of the adhesive 5 covering a projected base portion of the optical fiber 4 be substantially in a conical shape about the optical fiber 4 on the side of the tip end face 2b of the ferrule 1. This is because the optical fiber 4 is protected with the adhesive 5 so as not to be broken due to an excess stress locally applied to the projected base portion of the optical fiber 4, when the projected portion (portion on the tip end side from the projected base portion) of the optical fiber 4 is cut, and thereafter, the tip end face 2b of the ferrule 1 is polished together with the tip end surface of the optical fiber 4. By protecting the projected base portion of the optical fiber 4 by covering with the adhesive, and performing polishing, the tip end face 2b of the ferrule 1 and the tip end face of the optical fiber 4 can be polished in a desired spherical surface shape while the optical fiber 4 is prevented from being broken.

FIGS. 6(A), 6(B), 6(C), and 6(D) show states where the preferable adhesion shape of the adhesive 5 is not obtained compared with FIG. 5. As shown in FIG. 6(A), even if the projected base portion of the optical fiber 4 is covered with the adhesive 5, when the adhesion with respect to the tip end face 2b of the ferrule 1 is insufficient, an excess stress is concentrated in the projected base portion of the optical fiber 4 at a position where adhesion is insufficient during polishing, whereby the optical fiber 4 may be broken. FIG. 6(B) shows a state where the adhesive 5 does not adhere to the tip end face 2b of the ferrule 1. In this state, the protection effect of the optical fiber 4 due to the adhesive 5 cannot be obtained, and the occurrence ratio of the breakage of the optical fiber 4 during polishing is increased, compared with the state shown in FIG. 6(A). On the other hand, as shown in FIG. 6(C), there may be the case where although the adhesive 5 adheres to the tip end face 2b of the ferrule 1, the adhesion with respect to the optical fiber 4 is insufficient. In the case where the applied amount of the adhesive 5 is small, such an adhesion shape is obtained in most cases. Even in this case, the-protection effect of the optical fiber 4 due to the adhesive 5 cannot be expected, and the occurrence ratio of the breakage of the optical fiber 4 during polishing is increased.

The defective adhesion shapes as shown in FIGS. 6(A), 6(B), and 6(C) are caused mainly by the shortage of the applied amount of the adhesive 5. In contrast, when the applied amount of the adhesive 5 is excessive, as shown in FIG. 6(D), the adhesive 5 flows to an outer circumferential side from a required region (flat surface 2b1) of the tip end face 2b of the ferrule 1, whereby the adhesive 5 adheres to the chamfered portion 2b2. When such an adhesion defect due to the excessive flow of the adhesive 5 occurs, the adhesive 5 adhering to the chamfered portion 2b2 becomes an obstacle during polishing of the tip end face 2b of the ferrule 2, whereby the tip end face 2b cannot be polished in a desired spherical shape. As a result, the spherical surface center of the tip end face 2b and the core center of the optical fiber 4 are conspicuously shifted from each other, and the cores of the optical fibers 4 cannot be brought into physical contact with each other when the optical fiber connector plugs 10 are faced to be connected to each other, resulting in a connection defect.

Patent Document 1 Japanese Utility Model Registration No. 2578797 (pp. 1-4, FIGS. 1 to 3)

Patent Document 2 JP 10-246835 A (pp. 1-4, FIGS. 1 to 3)

Patent Document 3 WO 98/45739 (pp. 1-14, FIG. 1)

### DISCLOSURE OF THE INVENTION

### PROBLEM TO BE SOLVED BY THE INVENTION

In order to realize a preferable adhesion shape as shown in FIG. 5, the precise control and management of the applied amount and the like of the adhesive 5 are required, and skilled technique and expertise are also required in the insertion operation of the optical fiber 4. Therefore, various improvements have been focused on the control of the applied amount of the adhesive 5, and the management of temperature, humidity, and the like. Nonetheless, as shown in FIG. 6(D), a phenomenon that the adhesive 5 flows to an outer circumferential side from a required region (flat surface 2b1) of the tip end face 2b of the ferrule 1 to adhere to the chamfered portion 2b2 occurs often, which results in an increase in a defect occurrence ratio.

In order to avoid the connection defect under the condition that components are assembled into an optical fiber connector, in the case where an adhesion shape defect occurs due to the excessive flow of an adhesive, the optical fiber connector is discarded as a defective product, or it is required to be recycled. Such recycling is performed, for example, as follows. After a tip end face of a ferrule is once subjected to flat-polishing and before it is subjected to spherical polishing, an adhesive seeped out from the tip end face is stripped off with a sharp blade or the like. However, such treatment requires much labor and time, and there arises another problem in terms of quality management such as temporary lack of the precision compensation in the course of processing. Thus, when an adhesion shape defect occurs due to the excessive flow of an adhesive on the side of the tip end face of a ferrule when an optical fiber is inserted, the yield of a product is decreased, or a cumbersome operation for recycling, quality management, and the like are required, which causes a production cost to be high.

An object of the present invention is to provide a ferrule for an optical fiber connector capable of effectively preventing an adhesion shape defect due to an excessive flow of an adhesive on the side of a tip end face of a ferrule.

### MEANS FOR SOLVING THE PROBLEM

The inventors of the present invention have made various studies on the adhesion shape defect due to an excessive flow of an adhesive on the side of a tip end face of a ferrule when an optical fiber is inserted, and consequently found the following means for solving the problem to complete the present invention.

That is, the present invention provides a ferrule for an optical fiber connector, including: an inner hole through which an optical fiber is inserted; and a tip end face that is polished under a condition that the optical fiber is inserted in the inner hole to be fixed with an adhesive, in which the tip end face has a central side region including an opening of the inner hole and an outer circumferential side region on an outer circumferential side from the central side region, and wettability with respect to the adhesive is smaller in the outer circumferential side region than in the central side region.

Herein, the term “wetting” generally refers to a phenomenon that, when the surface of a solid comes into contact with a liquid, a part of the surface of the solid is replaced by an interface between the liquid and the solid. When a liquid droplet is placed on the surface of a solid, the liquid has a predetermined shape due to the properties of the solid and the liquid. In this case, an angle θ formed by a tangent drawn along the surface of the liquid droplet from a point where three phases of liquid, solid, and gas cross each other and the interface between the liquid and the solid is called a contact angle, which is used as a yardstick to measure the degree of wetting (wettability).

The tip end face of the ferrule is divided into a central side region including the opening of the inner hole and an outer circumferential side region on an outer circumferential side with respect to the central side region, and in the outer circumferential side region, wettability with respect to the adhesive is smaller than that in the central side region. The central side region of the tip end face is a region where an adhesive needs to adhere so as to form a preferable adhesion shape (e.g., adhesion shapes shown in FIGS. 5 and 1) on the tip end face side of the ferrule when an optical fiber (core) is inserted in the inner hole of the ferrule and fixed with the adhesive. In contrast, the outer circumferential side region is a region where an adhesive is not required to adhere so as to form a preferable adhesion form on a tip end face side of the ferrule. In the example shown in FIG. 1, the central side region is a flat surface 12b1 of the tip end face 12b before being polished, and the outer circumferential side region is a chamfered portion 12b2 on an outer circumferential side of the flat surface 12b1. Depending upon the property, size, and the like of the flat surface 12b1, the central side region may be set on an inner diameter side from the outer circumferential edge of the flat surface 12b1. In this case, the outer circumferential side portion of the flat surface 12b1 and the chamfered portion 12b2 form an outer circumferential side region.

In the tip end face of the ferrule, the wettability with respect to an adhesive is smaller in the outer circumferential side region than in the central side region. Therefore, when an optical fiber (core) is inserted in the inner hole of the ferrule, and fixed with an adhesive, on the tip end face side, the flow of the adhesive from the central side region to the outer circumferential side is blocked by the outer circumferential side region having relatively small wettability, and the adhesion of the adhesive on the tip end face side is regulated in a range of the central side region. Thus, a preferable adhesion shape of an adhesive is obtained on the tip end face side, and even in the case where the applied amount of the adhesive is somewhat too large, the adhesion of the adhesive to the outer circumferential side region (adhesion shape defect) due to the excess flow is prevented. Furthermore, even if the adhesive adheres to the outer circumferential side region, since the wettability in the outer circumferential side region is small, the adhesion force of the adhesive with respect to the region becomes relatively weak. Therefore, even in the case of performing recycling such as stripping off the adhesive adhering to the region, processing can be performed easier than the conventional example. Note that aside from the outer circumferential side region of the tip end face, the wettability with respect to the adhesive of the outer circumferential surface of the ferrule may be set to be small in the same way as in the outer circumferential side region of the tip end face.

The wettability of the outer circumferential side region of the tip end face is preferably set so that the contact angle θ with respect to the adhesive is 30° or more. The contact angel θ is a value measured in a mode shown in FIG. 7. More specifically, a test piece 2′ made of the same material as that of the ferrule and having the same surface property as that of the outer circumferential side region of the tip end face of the ferrule is held horizontal, the adhesive 5 is dropped in a predetermined amount to a surface 2a′ of the test piece 2′ in an environmental condition of a temperature of 25° C. (±5° C.) and a humidity of 60% (±5%), and allowed to stand as it is for 5 minutes. After that, among angles formed by a tangent L drawn along the surface of the liquid droplet from a point P where three phases of the liquid droplet of the adhesive 5, the surface 2a′ of the test piece 2′, and the air cross each other, and the surface 2a′ of the test piece 2′, the value obtained by measuring the angle θ on the liquid droplet side is a value of the contact angle θ. During assembly, in the case where an axial line of the ferrule is kept to be tilted with respect to a vertical line, or in the case where the axial line of the ferrule is held in parallel with the horizontal line, the adhesive is more likely to flow to an outer circumferential side due to the influence of a gravity. Therefore, the wettability of the outer circumferential side region of the tip end face is preferably set so that the contact angle θ with respect to the adhesive is 40° or more, and more preferably 50° or more.

As means for decreasing the wettability of the outer circumferential side region of the tip end face than that of the central side region, the outer circumferential side region may be surface-treated. This surface treatment may be performed by physical means or chemical means.

For example, there is means for increasing the surface roughness of the outer circumferential side region as the physical surface treatment. When the surface roughness is increased, the wettability with respect to the adhesive is decreased. More specifically, there are means for increasing the surface roughness by performing sandblast treatment with fine particles with respect to the outer circumferential side region, means for increasing the surface roughness by performing etching treatment with an etchant, means for increasing the surface roughness by implanting a particular element to the surface, and the like. Furthermore, as the chemical surface treatment, there is means for changing the chemical composition of the surface to adjust the wettability with respect to an adhesive. More specifically, there are means for forming a covering layer made of a material having small wettability with respect to an adhesive in the outer circumferential side region, means for dispersing particular ion species onto the surface by ion exchange treatment to decrease wettability, means for performing local heat treatment in the outer circumferential side region with respect to the ferrule made of crystalline glass or phase separative glass to generate different kinds of phases on the surface, thereby decreasing wettability, and the like.

Regarding the above-mentioned surface treatment, a plurality of kinds of treatments may be performed in a superimposed manner with respect to the outer circumferential side region. Alternatively, the outer circumferential side region is divided into a plurality of areas, and the kind of treatment may be changed depending upon the area. Furthermore, the outer circumferential region is divided into a plurality of areas, and treatment may be performed in such a manner that the wettability is decreased gradually from the area on the inner circumferential side to the area on the outer circumferential side. The surface treatment with respect to the outer circumferential side region may be performed over the entire circumference of the outer circumferential side region. Alternatively, the surface treatment may be performed only in a particular portion in a circumferential direction or may be performed in a plurality of portions in the circumferential direction in a dispersed manner. Furthermore, the surface treatment with respect to the outer circumferential side region may be performed over a part or an entirety of an outer circumferential surface of a ferrule beyond the outer circumferential side region. Furthermore, in addition to the surface treatment with respect to the outer circumferential side region, the central side region maybe subjected to surface treatment for increasing wettability with respect to an adhesive. Because of this, the degree of difference in wettability with respect to the adhesive is increased relatively between the outer circumferential side region and the central side region, whereby a more conspicuous effect is obtained.

There is no particular limit to the kind of the adhesive, as long as it can allow an optical fiber to adhere strongly to a ferrule. For example, a phenol resin-based adhesive, amino resin-based adhesive, a cyanoacrylate-based adhesive, and the like, as well as epoxy-based adhesive, silicone adhesive, acrylic adhesive, and the like can be used. Furthermore, these adhesives may be used in combination of at least two kinds.

The outer circumferential side region of the tip end face is, for example, a chamfered portion provided on the tip end face. The surface shape of the chamfered portion is not particularly limited, and a taper surface, an R-surface, a spherical surface, a composite curved surface thereof, and other arbitrary surface shapes can be adopted. The boundary between the chamfered portion and the central side region, and the boundary between the chamfered portion and the outer circumferential surface may not be clearly identified visually. For example, a ring-shaped surface region with a width of 0.01 mm or more only needs to be recognized in a boundary portion between the central side region and the outer circumferential surface. The surface treatment for decreasing wettability may be performed with respect to the ring-shaped surface region. For example, surface treatment can be performed by pressing a roller or the like coated with a surface treatment agent to the ring-shaped surface region. This surface treatment is not necessarily required to be performed over an entire circumference of the ring-shaped surface region. The surface treatment may be performed in a particular portion in a circumferential direction or may be performed in a plurality of portions in a circumferential direction in a dispersed manner. More specifically, a portion in which the adhesive is likely to flow is specified depending upon the holding angle of the ferrule at a time of assembly, so that the surface treatment only needs to be performed in the particular portion. Furthermore, even in the case where the surface treatment is performed over the entire circumference of the ring-shaped surface region, the surface treatment is not necessarily required to be performed in a uniform width, and the treatment width may be varied in the circumferential direction, if required.

As the chemical surface treatment of decreasing the wettability of the outer circumferential side region of the tip end face, means for forming a covering layer by allowing an organic compound to adhere to the surface of the outer circumferential side region, or forming a surface layer on the surface of the outer circumferential side region by a chemical bond of an organic compound.

The thickness of the above-mentioned covering layer or the surface layer is not particularly limited. For example, even a very thin film at a monomolecular layer level can be used as long as it has a function of adjusting the wettability with respect to the adhesive. Furthermore, the covering layer or the surface layer is used for adjusting the wettability with respect to the adhesive, and a part or an entirety thereof is to be removed later by polishing. Therefore, there is no problem in whether the binding force of the covering layer or the surface layer with respect to the surface of the outer circumferential side region is strong or weak. The covering layer or the surface layer may or may not remain at a stage of a product.

As means for forming the above-mentioned covering layer or the surface layer, for example, dipping in an organic solvent (treatment liquid) in which an organic compound is dispersed or dissolved; coating with a treatment liquid; the use of a spray, a dispenser, or the like; the attachment of an organic compound material processed in a seal shape; printing, transfer, or the like of an organic compound material; and the like can be adopted.

The organic compound is at least one compound selected from silane-based, siloxane-based, silazane-based, titanate-based, and aluminate-based compounds.

Herein, the silane-based, siloxane-based, silazane-based, titanate-based, and aluminate-based compounds refer to those which contain silane-based, siloxane-based, silazane-based, titanate-based, and aluminate-based functional groups in a part of a structure.

As the above-mentioned silane-based compound, an organic silicon compound represented by the following general chemical formula (1) is preferable.
R¹Si(OX)₃ (1)
where, R¹ is a hydrocarbon group with 1 to 10 carbon atoms, which may contain F; and X is a monovalent hydrocarbon group containing a methyl group and an ethyl group.

As the siloxane-based compound, an organic silicon compound represented by the following general chemical formula (2) is preferable.
{R²Si(OH)ₐ(OY)_{b}O_{(m-1)/m}}ₘ (2)
where, R² is a monovalent hydrocarbon group with 3 to 20, preferably 4 to 10 carbon atoms, which may be the same or different. Specific examples of R² include a linear or branched propyl group, butyl group, hexyl group, octyl group, decyl group, dodecyl group, octadecyl group, and phenyl group. Y is a monovalent hydrocarbon group with 1 to 10, preferably 1 to 5 carbon atoms, which may be the same or different. Specific examples of Y include a methyl group, an ethyl group, and a propyl group. Furthermore, a is the number of 0 to 2, and b is the number of 0 to 2, which satisfy a+b=(m+2)/m, where m is the repetitive number of a structural unit. In the chemical formula (2), the siloxane compound is an oligomer of a dimmer or more. The siloxane compound does not have the repetitive number of the same structural unit, but is a mixture of oligomers having the repetitive number of a plurality of structural units, so that m represents an average value of the repetitive numbers of the structural units.

Furthermore, the siloxane compound represented by the chemical formula (2) can be produced by hydrolysis condensation of alkyltrialkoxysilane.

Furthermore, as the other siloxane compounds, an organic silicon compound represented by the following general chemical formula (3) is preferable. 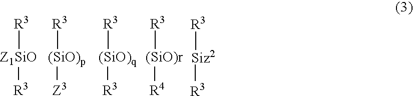
where R³ is a methyl group, and R⁴ is a monovalent hydrocarbon group with 3 to 20 carbon atoms, which may be the same or different. Specific examples of R³ include a propyl group, an octyl group, an octadecyl group, and a phenyl group. Furthermore, Z¹, Z², and Z³ are R³, R⁴ or a group represented by the following chemical formula (4). In the chemical formula (3), p is the number of 0 to 5, q is the number of 0 to 50, and r is the number of 0 to 50. The siloxane compound represented by the chemical formula (3) contains at least one group represented by the chemical formula (4) in one molecule.
-A-Si(OR⁵)₃ (4)
where A is an oxygen atom or a divalent hydrocarbon group with 2 to 10 carbon atoms. Examples of A include an ethylene group, a propylene group, and a phenylene group. In particular, an oxygen atom or an ethylene group is preferable. R⁵ is a monovalent hydrocarbon group with 1 to 10 carbon atoms, and examples of R⁵ include a methyl group, an ethyl group, and a propyl group.

Furthermore, as the silazane compound, an organic silicon compound represented by the following general chemical formula (5) is preferable.
R⁶Si(NH)_{3/2} (5)
where R⁶ is a monovalent hydrocarbon group with 3 to 20 carbon atoms, which may be the same or different. Specific examples of R⁶ include a linear or branched propyl group, butyl group, hexyl group, octyl group, decylgroup, dodecylgroup, octadecylgroup, andphenylgroup.

The silazane compound represented by the chemical formula (5) is a silazane oligomer obtained by the reaction between corresponding halosilane (preferably, chlorosilane) andammonia, andisdesirably used by being dissolved in an organic solvent.

Furthermore, as the titanate-based compound, isopropyl triisostearoyl titanate can be used. Furthermore, as the aluminate-based compound, octadecylacetoacetate aluminum diisopropylate can be used.

As the structure of an organic compound (surface treatment agent) used for surface treatment, it is important that functional groups of a material used as an adhesive and a surface treatment agent, which determine the wettability between the material and the surface treatment agent, have properties opposed to each other. For example, in the case of using a compound having a hydrophilic functional group such as an OH group or a COOH group as the adhesive, a compound having a hydrophobic functional group is used as the surface treatment agent. On the contrary, in the case of using a compound having a hydrophobic functional group as the adhesive, a compound having a hydrophilic functional group is used as the surface treatment agent.

As the surface treatment agent, considering the affinity regarding the wettability with respect to the adhesive to be used, and the usability, cost efficiency, and the like, an optimum organic compound may be selected to be used.

In the case of performing surface treatment for increasing the surface roughness in the outer circumferential side region of the tip end face, the surface treatment needs to be performed to such a degree that the strength characteristics of the ferrule are not degraded. The difference between the surface roughness before the surface treatment and the surface roughness after the surface treatment is 0.5 μm or more, preferably 1.0 μm or more in terms of an Ra value. Herein, the Ra value is one of the criteria of the surface roughness defined by JIS B 0601-1994, and is measured by a probe-type surface roughness meter or a laser-type surface roughness meter.

Although the material for the ferrule is not particularly limited, the ferrule is preferably formed of crystallized glass (glass ceramic) or glass. At least a portion of the ferrule at which the core of an optical fiber fixedly adheres (e.g., the capillary tube portion 2 shown in the figure) only needs to be formed of crystallized glass or glass, and the other portions (e.g., the flange portion 3 shown in the figure) may be formed of the other materials, e.g., a metallic or organic material, or ceramic. Furthermore, in the portion of the ferrule at which the core of the optical fiber fixedly adheres, crystallized glass and glass maybe present together. Furthermore, the crystallized glass or glass forming the ferrule may be supplied with a transition element or the like, and colored using a colloid coloring element or the like, if required.

The composition of the crystallized glass or glass forming the ferrule can be selected optimally in accordance with the optical fiber to be used. Furthermore, by combining a plurality of materials and adopting a laminate structure, the characteristics of the ferrule such as the light transmittance and strength can be adjusted.

For example, as the crystallized glass or glass forming the ferrule, those which contain Si, Al, or Ti in amounts of 10% by mass or more in terms of oxide can be used. The crystallized glass or glass contains 10% by mass or more of Si as SiO₂, and/or 10% by mass or more of Al as Al₂O₃, and/or 10% by mass or more of Ti as TiO₂. In particular, in the case of performing surface treatment using the above-mentioned surface treatment agent, the crystallized glass or glass can be chemically bonded sufficiently to the surface treatment agent, which is preferable.

### EFFECTS OF THE INVENTION

The present invention exhibits the following effects.

(1) The adhesion shape defect due to the excessive flow of the adhesive on the tip end face side of the ferrule can be prevented effectively. This enables the defect occurrence ratio in the step of inserting an optical fiber can be reduced. Furthermore, since the projected base portion of the optical fiber can be protected sufficiently by covering with an adhesive on the tip end face side of the ferrule, the defect occurrence ratio due to the breakage of the optical fiber in the polishing step can be reduced.

(2) Since it is not required to perform various fine managements in the step of inserting an optical fiber, such as the management of the amount of an adhesive, the cost required for the step of inserting an optical can be reduced considerably.

(3) By selecting a surface treatment agent in accordance with an adhesive to be used, it is possible to perform optimum surface treatment with respect to various ferrules for an optical fiber connector.

(4) It is possible to provide an inexpensive ferrule for an optical fiber connector having high reliability.

### BRIEF DESCRIPTION OF THE DRAWINGS

FIG. 1 is a view schematically showing a state where an optical fiber is fixed to a ferrule for an optical fiber connector according to an embodiment with an adhesive.

FIG. 2 is a cross-sectional view showing an exemplary configuration of a general ferrule for an optical fiber connector.

FIG. 3 is a cross-sectional view showing an exemplary configuration of an optical fiber connector plug.

FIG. 4 is a cross-sectional view showing an exemplary connection of an optical fiber connector plug.

FIG. 5 is an enlarged view schematically showing a tip end portion of a ferrule in the step of inserting an optical fiber.

FIG. 6 is an enlarged view schematically showing a tip end portion of a ferrule in the step of inserting an optical fiber.

FIG. 7 is a view schematically showing a mode of measurement of a contact angle e with respect to an adhesive.

### PREFERRED EMBODIMENTS OF THE INVENTION

Hereinafter, an embodiment of the present invention will be described.

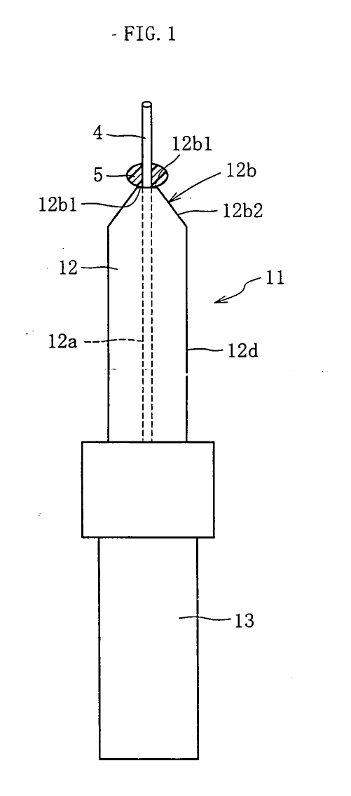

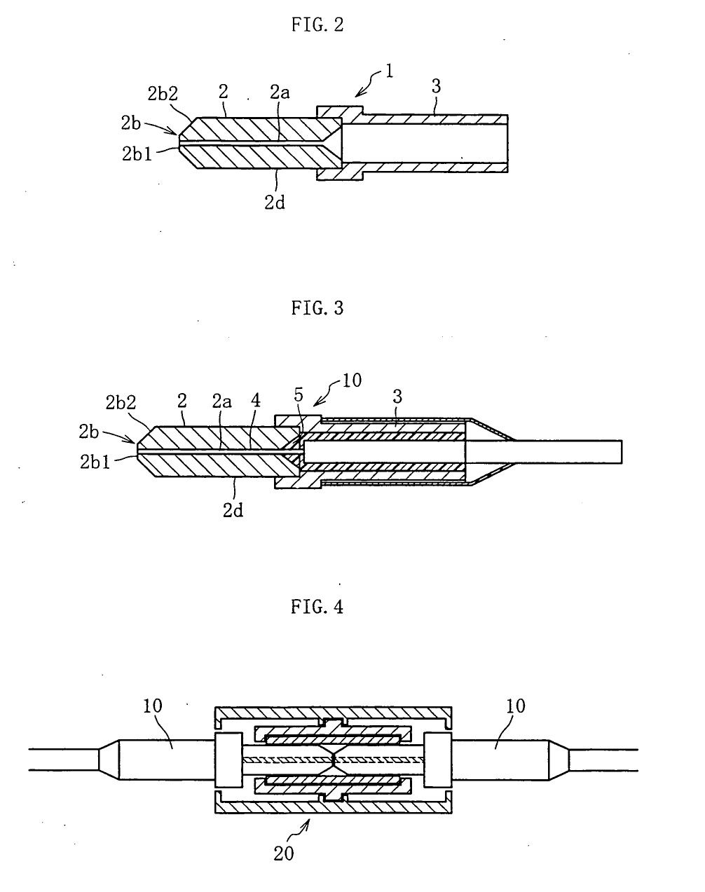

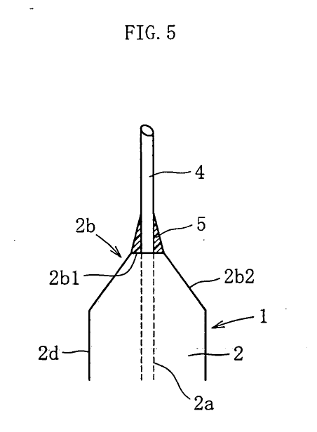

FIG. 1 shows a state in which an optical fiber 4 is fixed to a ferrule 11 of this embodiment with an adhesive. The ferrule 11 of this embodiment constitutes an MU-type optical fiber connector.

The ferrule 11 is made of crystallized glass, and is composed of a capillary tube portion 12, and a flange portion 13 connected to a rear end portion of the capillary tube portion 12. The capillary tube portion 12 includes an inner hole 12a through which the optical fiber 4 (core) made of quartz glass is inserted, a tip end face 12b, and an outer circumferential surface 12d. The tip end face 12b is composed of a flat surface 12b1 on a central side including a tip end opening of the inner hole 12a and a chamfered portion 12b2 provided on an outer circumferential side of the flat surface 12b1. In this embodiment, the chamfered portion 12b2 is formed in a tapered surface. In this embodiment, the flat surface 12b1 of the tip end face 12b is a central side region, the chamfered portion 12b2 is an outer circumferential side region, and the chamfered portion 12b2 is subjected to surface treatment so that the wettability with respect to an adhesive 5 is smaller than that of the flat surface 12b1.

During assembly, the inner hole 12a of the ferrule 11 is previously filled with the adhesive 5, and the optical fiber 4 is also coated with the adhesive 5. Then, the optical fiber 4 is inserted in the inner hole 12a from the flange portion 13 side, and a tip end portion thereof is allowed to project in a predetermined amount from the tip end face 12b of the ferrule 11. The adhesive 5 filled in the inner hole 12a and applied to the optical fiber 4 is pushed out from the tip end opening of the inner hole 12a along with the insertion of the optical fiber 4, and is mounded on the flat surface 12b1 of the tip end face 12b. The mounded adhesive 5 is apt to flow toward the chamfered portion 12b2 on its outer circumferential side from the flat surface 12b1. However, the wettability of the chambered portion 12b2 is small, so that its flow is inhibited, and the adhesion of the adhesive 5 is regulated in a range of the flat surface 12b1. This prevents the adhesion of the adhesive 5 to the chambered portion 12b2.

When the adhesive 5 is cured in the above-mentioned state, the adhesive 5 adheres to both the flat surface 12b1 of the tip end face 2b of the ferrule 1 and the projected base portion of the optical fiber 4, thereby protecting the projected base portion of the optical fiber 4 by covering. After that, the tip end portion is cut from the projected base portion of the optical fiber 4, and the tip end face 2b of the ferrule 1 is polished together with the tip end face of the optical fiber 4 to be mirror-finished in a spherical surface shape. During polishing, the projected base portion of the optical fiber 4 is protected by the adhesive 5 so as to be polished without being broken. The flat surface 12b1 of the tip end face 2b of the ferrule 1 may be formed in a convex surface shape.

### EXAMPLE 1

One hundred ferrules 11 produced in the same way were prepared. The chamfered portion 12b2 of the tip end face 12b of each ferrule 11 was subjected to surface treatment using a fluorine-based silane coupling agent as a surface treatment agent (Example 1). The material for the prepared ferrule 11 was crystallized glass containing 55% or more of SiO₂, 14% or more of Al₂O₃, and 1% or more of TiO₂ in terms of a mass percentage, in which a β-quartz solid solution or β-spodumene solid solution was precipitated as precipitation crystal. The surface treatment was performed as follows. First, the above-mentioned surface treatment agent was diluted 10-fold with a fluorine-based inactive liquid, and applied to the chamfered portion 12b2 of the tip end face 12b of the ferrule 11. Then, the resultant ferrule 11 was allowed to stand at room temperature for about several minutes until the fluorine-based inactive liquid volatilized, and thereafter, was heated in an atmosphere of 100° C. for 10 minutes in a box-type drying furnace.

In 100 ferrules 11 subjected to the above-mentioned surface treatment (Example 1), the optical fiber 4 was fixed with the adhesive 5, and the adhesive was cured by heating. After that, the adhesion shape of the adhesive 5 on the side of the tip end face 12b was observed.

As a result of the observation, in the ferrule 11 of Example 1, the adhesion shape of the adhesive 5 on the side of the tip end face 12b exhibited the shape as shown in FIG. 1, and no adhesion of the adhesive 5 to the chamfered portion 12b2 of the tip end face 12b was observed.

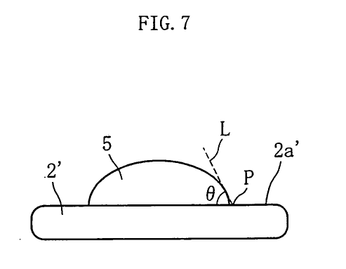

Furthermore, a test piece made of the same material as that of the ferrule 11 of Example 1 and subjected to the same surface treatment as that of the chamfered portion 12b2 of the ferrule 11 was produced. The adhesive 5 of 0.5 cm³ was dropped onto a surface 2a′ of a test piece 2′ in the embodiment shown in FIG. 7, and a contact angle θ was measured at room temperature using a contact angle measure (produced by Kyowa Interface Science Co. Ltd.) to obtain the contact angle θ of 38°.

On the other hand, as a comparative example, 100 ferrules produced under the same condition as that of Example 1 were prepared. An optical fiber was fixed with an adhesive under the same condition as that of Example 1, without performing the above-mentioned surface treatment. After the adhesive was cured by heating, the adhesion shape of the adhesive on the side of the tip end face was observed.

As a result of the observation, in the ferrules of Comparative Example, the adhesive extended off from the flat surface of the tip end face to adhere to the chamfered portion in 12 ferrules among 100 ferrules. In 5 ferrules among them, the flow amount to the chamfered portion was large, and the adhesive adhered strongly to the chamfered portion, so that recycling was difficult.

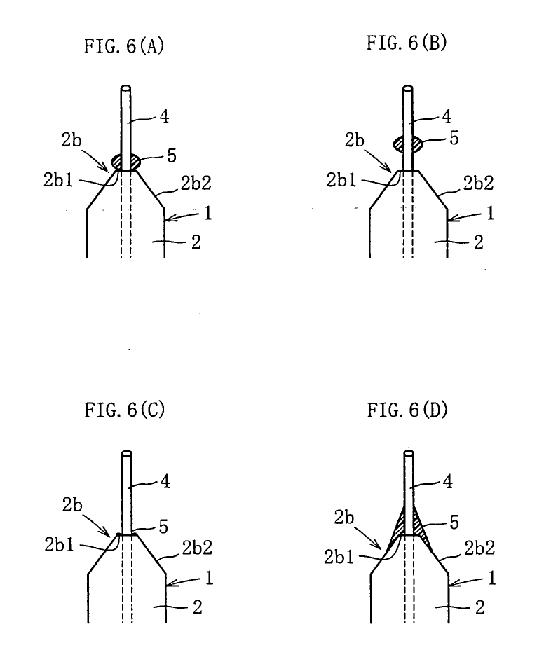

Furthermore, in 20 ferrules of Example 1, an excessive amount of adhesive was applied so as to obtain an adhesion shape as shown in FIG. 6(D), whereby the adhesive was intentionally allowed to adhere to the chamfered portion of the tip end face. Then, the adhesive was cured by heating, and thereafter, the peeling property of the adhesive adhering to the chamfered portion was checked.

Consequently, in the ferrules of Example 1, it was found that the adhesive that flowed to the chamfered portion to be cured thereon did not strongly adhere to the surface of the chamfered portion, and was able to be removed easily with a weak force, using a sharp needle.

On the other hand, 20 ferrules of Comparative Example were checked for the peeling property of the adhesive adhering to the chamfered portion under the same condition as that of Example 1. In any of the ferrules, the adhesive strongly adhered to the surface of the chamfered portion, and even if the adhesive was tried to be scraped off with a sharp blade or the like, it was not able to be removed easily.

### EXAMPLE 2

Ferrules 11 made of glass composed of 73% of SiO₂, 7% of Al₂O₃, 10% of B₂O₃, 10% of RO (R is an alkaline-earth metal element), 3% of M₂O (M is an alkaline metal element), and 7% of borosilicate glass in terms of a mass percentage were produced. The chamfered portion 12b2 of the tip end face 12b of each ferrule 11 was subjected to surface treatment in the same way as in Example 1 (Example 2). In Example 2, the outer circumferential surface 12d of the ferrule 11, as well as the chamfered portion 12b2 were similarly subjected to the surface treatment.

The adhesion shape of the adhesive 5 on the side of the tip end face 12b of each ferrule 11 was observed in the same way as in Example 1. Consequently, in 90% or more of the ferrules 11, the adhesion shape of the adhesive 5 on the side of the tip end face 12b exhibited the shape as shown in FIG. 1, and no adhesion of the adhesive 5 to the chamfered portion 12b2 of the tip end face 12b was observed. Furthermore, the ferrule 11, in which the adhesive 5 extended off from the flat surface 12b1 of the tip end face 12b to adhere to the chamfered portion 12b2 and the outer circumferential surface 12d, was subjected to peeling processing for recycling. The processing was able to be completed in a period of time that was a half or less of the conventional example.

### EXAMPLE 3

One hundred ferrules 11 produced in the same way were prepared, and the chamfered portion 12b2 of the tip end face 12b of each ferrule 11 was subjected to a sandblast treatment using alumina fine powder subjected to a silane coupling treatment as surface treatment (Example 3). The material for the ferrule 11 used in Example 3 was the same as that of Example 1. Furthermore, the sandblast treatment was performed under the condition of masking the surface that was not required to be treated. As a result of the sandblast treatment, the surface roughness of the chamfered portion 12b2 of the tip end face 12b increased by 0.7 μm in terms of an Ra value compared with that before the treatment (0.01 to 1.0 μm in terms of an Ra value), and hence, became larger than that of the flat surface 12b1.

In 100 ferrules 11 subjected to the above-mentioned surface treatment (Example 3), the optical fiber 4 was fixed with the adhesive 5, and the adhesive was cured by heating. After that, the adhesion shape of the adhesive 5 on the side of the tip end face 12b was observed.

As a result of the observation, in the ferrules 11 of Example 3, the adhesion shape of the adhesive 5 on the side of the tip end face 12b exhibited the shape as shown in FIG. 1, and no adhesion of the adhesive 5 to the chamfered portion 12b2 of the tip end face 12b was observed.

Furthermore, a test piece made of the same material as that of the ferrule 11 of Example 3 and subjected to the same surface treatment as that of the chamfered portion 12b2 of the ferrule 11 was produced. The adhesive 5 of 0.5 cm³ was dropped onto a surface 2a′ of a test piece 2′ in the embodiment shown in FIG. 7, and a contact angle θ was measured at room temperature using a contact angle measure (produced by Kyowa Interface Science Co. Ltd.) to obtain the contact angle θ of 34°.

1. A ferrule for an optical fiber connector, comprising: an inner hole through which an optical fiber is inserted; and a tip end face that is polished under a condition that the optical fiber is inserted in the inner hole to be fixed with an adhesive,
characterized in that the tip end face has a central side region including an opening of the inner hole and an outer circumferential side region on an outer circumferential side from the central side region, and wettability with respect to the adhesive is smaller in the outer circumferential side region than in the central side region.

2. The ferrule for an optical fiber connector according to claim 1, characterized in that the outer circumferential side region comprises a chamfered portion provided on the tip end face.

3. The ferrule for an optical fiber connector according to claim 1, characterized in that the outer circumferential side region has a contact angle with respect to the adhesive of 300 or more.

4. The ferrule for an optical fiber connector according to claim 1, characterized in that the outer circumferential side region is subjected to surface treatment by adhesion or chemical bonding of an organic compound to a surface of the outer circumferential side region.

5. The ferrule for an optical fiber connector according to claim 4, characterized in that the organic compound is at least one compound selected from the group consisting of a silane-based compound, a siloxane-based compound, a silazane-based compound, a titanate-based compound, and an aluminate-based compound.

6. The ferrule for an optical fiber connector according to claim 1, characterized in that the outer circumferential side region is subjected to surface treatment to have a surface roughness larger than that of the central side region.

7. The ferrule for an optical fiber connector according to claim 1, characterized in that the ferrule is made of crystallized glass or glass.

8. The ferrule for an optical fiber connector according to claim 7, characterized in that the crystallized glass or glass contains Si, Al, or Ti in an amount of 10% by mass or more in terms of an oxide.

9. A method of producing a ferrule for an optical fiber connector in which an optical fiber is inserted in an inner hole of the ferrule and fixed with an adhesive, and a tip end face of the ferrule is polished with the optical fiber,
the method being characterized by comprising: dividing the tip end face into a central side region including an opening of the inner hole and an outer circumferential side region on an outer circumferential side from the central side region; and subjecting the outer circumferential side region to surface treatment to have wettability with respect to the adhesive smaller than that of the central side region.
